(19) United States
(12) Patent Application Publication
(10) Pub. No.: US 2023/0104103 A1
(43) Pub. Date: Apr. 6, 2023

(54) CUSTODIAL SYSTEMS FOR NON-FUNGIBLE TOKENS

(71) Applicant: American Express Travel Related Services Company, Inc., New York, NY (US)

(72) Inventors: Alaric M. Eby, Scottsdale, AZ (US); Andras L. Ferenczi, Phoenix, AZ (US); Jaime A. Cruz-Herrera, Jersey City, NJ (US)

(21) Appl. No.: 17/492,021

(22) Filed: Oct. 1, 2021

(51) Int. Cl. G06Q 20/12; G06Q 20/36; G06Q 20/38; G06Q 20/02; H04L 9/32; H04L 9/30

(52) U.S. Cl. CPC G06Q 20/1235; G06Q 20/363; G06Q 20/3825; G06Q 20/3829; G06Q 20/389; G06Q 20/38215; G06Q 20/3678; G06Q 20/02; H04L 9/3247; H04L 9/3213; H04L 9/30

(57) ABSTRACT

Disclosed are various embodiments for using custodial systems to maintain ownership of digital assets and facilitate transfers of digital assets between individuals. To facilitate a user taking possession of a digital asset, the custodial system could update an owner identifier for a digital asset in an asset ledger to include a public key of an asset custodian, the public key of the asset custodian indicating that the asset custodian is the owner of the digital asset. The custodial system could then provide a verifiable credential to an identity wallet, the verifiable credential being linked to the digital asset in the digital asset ledger. Subsequently, the custodial system could create an asset record that stores an owner identifier in association with an asset identifier for the digital asset, the owner identifier representing a user of the identity wallet.

### BACKGROUND

Many users own, purchase, or sell non-fungible tokens (NFTs) using various marketplaces. Generally, NFTs, once purchased, are transferred to an owner's wallet. The public key of the owner's wallet is used as the wallet address identifying who owns the NFT. The private key of the owner's wallet can be used to authorize transactions or transfers of the NFT. If the owner of the NFT loses his or her private key, however, then the owner might also lose the ability to verify ownership of his or her NFT. Likewise, if the private key were stolen, someone could transfer ownership of the NFT to another's wallet address.

Moreover, securing, storing, and tracking public-private key pairs for personal wallets can be both time-consuming and technically challenging to many users. For example, hardware or software wallets connected to the internet allow users to conveniently and easily authorize or verify transactions. However, they present a risk of private key theft if the wallets are compromised. In contrast, hardware or software wallets that are disconnected from the internet are more secure, but more cumbersome to use to authorize or verify transactions.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIGS. 2-5 are flowcharts illustrating examples of functionality implemented in the network environment of FIG. 1 according to various embodiments of the present disclosure.

### DETAILED DESCRIPTION

Disclosed are various approaches for managing ownership of digital assets, such as non-fungible tokens (NFTs) stored on a distributed ledger, using third-parties as custodians. When ownership of a digital asset, such as an NFT, is transferred between user, the NFT is often updated to reflect the wallet address of the new owner. However, many distributed ledgers (e.g., the ETHEREUM® blockchain) charge transaction fees in order to transfer the NFT from a first wallet address to a second wallet address. Unfortunately, transaction fees can be quite costly when there is a significant load on the distributed ledger or demand for distributed ledger resources. Moreover, each wallet address often serves as the public key of a public-private key-pair, with the users being responsible for maintaining the security and confidentiality of the private key needed to authorize transactions involving their wallets. Many non-technical users are ill-equipped to perform properly secure their private keys and maintain their confidentiality.

To solve these problems, digital assets such as NFTs can be bought, sold, and transferred while in the possession of the custodian. The custodian can take ownership of the NFT by associating the NFT with the wallet address of the custodian, while the custodian can keep its own records as to who the true, beneficial owner of the NFT currently is. Subsequent transfers between users, customers, or clients of the custodian can be processed by update the records maintained by the custodian without having to update the wallet address associated with the NFT. As a result, transaction fees charged by the distributed ledger for transferring ownership of an NFT between individuals can be eliminated. Moreover, the individuals can avoid having to maintain the security and confidentiality of their private keys associated with their wallet addresses because they can rely on the custody service to perform that service. As a result, the efficiency and security of the computing systems involved are increased.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

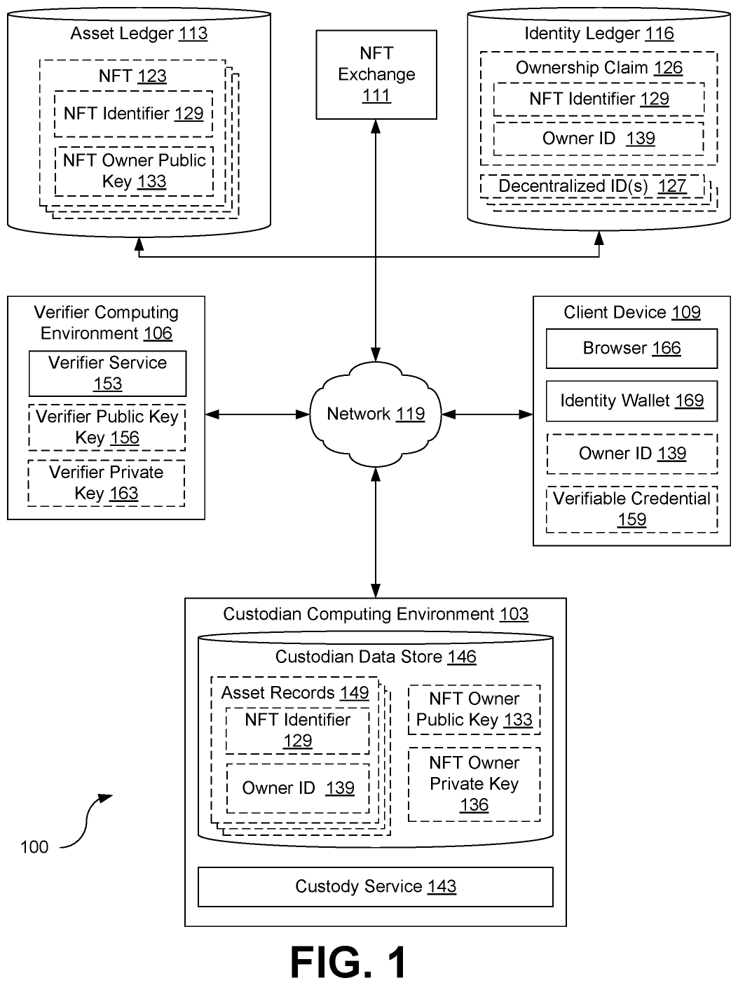

With reference to FIG. 1, shown is a network environment 100 according to various embodiments. The network environment 100 can include a custodian computing environment 103, a verifier computing environment 106, at least one client device 109, an exchange 111, an asset ledger 113, and an identity ledger 116, which can be in data communication with each other via a network 119.

The network 119 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 119 can also include a combination of two or more networks 119. Examples of networks 119 can include the Internet, intranets, extranets, virtual private networks (VPNs), and similar networks.

The custodian computing environment 103, the verifier computing environment 106, and/or the exchange 111 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the custodian computing environment 103, the verifier computing environment 106, and/or the exchange 111 can employ a plurality of computing devices that can be arranged in one or more server banks or computer banks or other arrangements. Such computing devices can be located in a single installation or can be distributed among many different geographical locations. For example, the custodian computing environment 103, the verifier computing environment 106, and/or the exchange 111 can include a plurality of computing devices that together can include a hosted computing resource, a grid computing resource or any other distributed computing arrangement. In some cases, the custodian computing environment 103, the verifier computing environment 106, and/or the exchange 111 can correspond to an elastic computing resource where the allotted capacity of processing, network, storage, or other computing-related resources can vary over time.

The asset ledger 113 and the identity ledger 116 both represent synchronized, eventually consistent, data stores spread across multiple nodes in different geographic or network locations. Each node in the asset ledger 113 or the identity ledger 116 can contain a replicated copy of the asset ledger 113 or the identity ledger 116, including all data stored in the asset ledger 113 or the identity ledger 116. Records of transactions involving the asset ledger 113 or the identity ledger 116 can be shared or replicated using a peer-to-peer network connecting the individual nodes that form the asset ledger 113 or the identity ledger 116. Once a transaction or record is recorded in the asset ledger 113 or the identity ledger 116, it can be replicated across the peer-to-peer network until the record is eventually recorded with all nodes. Various consensus methods can be used to ensure that data is written reliably to the asset ledger 113 or the identity ledger 116. In some implementations, data, once written to the asset ledger 113 or the identity ledger 116, is immutable. Examples of a distributed data store that can be used for the asset ledger 113 or the identity ledger 116 can include various types of blockchains, distributed hash tables (DHTs), and similar data structures. Various data can be stored in the asset ledger 113 or the identity ledger 116. For example, the asset ledger 113 could store one or more non-fungible tokens (NFTs) 123, while the identity ledger 116 could store one or more ownership claims 126 and/or one or more decentralized identifiers 127.

An NFT 123 represents a non-fungible unit of data stored in the asset ledger 113. Because an NFT 123 is non-fungible, it can be used for a variety of purposes where fungibility is undesirable. For example, an NFT 123 could be used to represent ownership of a non-fungible digital or physical item, such as ownership of a song, a work of art, a post to a website, title to property (e.g., real estate or personal property), etc. Transfer of ownership of the NFT 123 can therefore represent a transfer of ownership of the asset linked to the NFT 123. Accordingly, in various implementations of the present disclosure, an NFT 123 can include an NFT identifier 129, an NFT owner public key 133, and other data such as a description of an asset linked to the NFT 123 or a location of the asset linked to the NFT 123.

The NFT identifier 129 represents the unique identifier for a respective NFT 123, which uniquely identifies the NFT 123 with respect to other NFTs 123. The NFT identifier 129 can be formatted in various ways, depending on which standard the NFT 123 complies with. Examples of NFT standards include the ETHEREUM ERC-721 standard, ETHEREUM ERC-1155 standard, the FLOW blockchain NFT standard, etc.

The NFT owner public key 133 represents a public key associated with an owner of the NFT 123. The NFT owner public key 133 can be used to uniquely identify the owner of the NFT 123. The NFT owner public key 133 can also be used to assert or verify ownership of an NFT 123 by its owner. In some implementations, the NFT owner public key 133 can be referred to as the wallet address or owner address for the NFT 123. For each NFT owner public key 133, there can also be a respective NFT owner private key 136. The NFT owner private key 136 allows for the owner of an NFT 123 to verify his or her ownership by generating cryptographically secure signatures that can be verified using the NFT owner public key 133. Accordingly, the NFT owner private key 136 may be stored in a non-public location separate from the asset ledger 113.

An ownership claim 126 can represent a claim of ownership to a digital asset 123. Such a claim could be made by the same entity that controls or is associated with the NFT owner public key 133. However, the ownership claim 126 could also be associated with a third-party who claims ownership of the NFT 123 held in the name of a custodian or trustee. For example, a custodian may use his or her public key as the NFT owner public key 133 to identify the custodian in the asset ledger 113 as the owner of the NFT 123. However, the custodian could be managing the NFT 123 on behalf of another. To allow for third-parties to verify the beneficial owner or true owner of the NFT 123, an ownership claim 126 could be stored in the identity ledger 116. The ownership claim 126 could also include the NFT identifier 129 that is subject to the ownership claim 126 and an owner identifier 139 representing the individual claiming to own the NFT 123. The ownership claim 126 could also be implemented using various standards, such as the World Wide Web Consortium's (W3C's) Decentralized Identifier (DID) standard.

The decentralized identifiers (DIDs) 127 represent identifiers of individuals or entities and can be stored in the identity ledger 116. A DID 127 can represent any self-sovereign identifier used by an individual to assert his or her identity to others and may be stored in the identity ledger 116 to allow others to verify the individual's identity. Accordingly, in some implementations, the DID 127 can include a public key of a public-private key pair controlled by the individual. The DID 127 could also include one or more cryptographic signatures generated using private keys of other individuals or entities who have certified or verified that the DID 127 identifies the individual using the DID 127 as an identifier. A DID 127 can be implemented using a variety of approaches, such as the World Wide Web Consortium's (W3C's) Decentralized Identifier (DID) standard. In some implementations of the present disclosure, the owner identifier 139 could be implemented as a DID 127.

Various applications or other functionality can be executed in the custodian computing environment 103 and the verifier computing environment 106. The components executed by the custodian computing environment 103 can include a custody service 143, and potentially other applications, services, processes, systems, engines, or functionality not discussed in detail herein.

Also, various data used by the custodian computing environment 103 could be stored in a custodian data store 146 that is accessible to the custodian computing environment 103. The custodian data store 146 can be representative of a plurality of data stores, which can include relational databases or non-relational databases such as object-oriented databases, hierarchical databases, hash tables or similar key-value data stores, as well as other data storage applications or data structures. The custodian data store 146 can also include secure or limited access data storage for storing sensitive information, such as cryptographic keys. Moreover, combinations of these databases, data storage applications, and/or data structures may be used together to provide a single, logical, data store. The data stored in the custodian data store 146 is associated with the operation of the various applications or functional entities described below. This data can include one or more asset records 149, an NFT owner public key 133, a respective NFT owner private key 136, and potentially other data.

The asset records 149 represent data associated with individual NFTs 123 managed by the custody service 143 on behalf of others. Each asset record 149 can include the NFT identifier 129 of the respective NFT 123 and the owner identifier 139 of the individual claiming ownership of the NFT 123 managed by the custody service 143.

The custody service 143 can be executed to perform a variety of operations on behalf of individuals. For example, the custody service 143 could be executed to transfer ownership of an NFT 123 from one individual to another. The custody service 143 could also be executed to acquire or dispose of the NFT 123, such as in situations where the NFT 123 is not currently owned or controlled by the custody service 143. The custody service 143 can also create, revoke, or update ownership claims 126 stored in the identity ledger 116 for individual NFTs 123. As part of these processes, the custody service 143 can also create or issue verifiable credentials 159 to client devices 109 so that owners of NFTs 123 can verify their ownership to third-parties. The custody service 143 can also be configured to communicate with the exchange 111, in order to allow customers to purchase or sell NFTs 123 using the exchange 111 while the custody service 143 maintains custody of the respective NFTs 123.

The verifiable credential 159 can represent any digital credential. For example, the verifiable credential 159 could be implemented using the World Wide Web Consortium (W3C) standard for verifiable credentials. A verifiable credential 159 can include a number of components, such as the identity of the issuer of the verifiable credential 159, a timestamp indicating when the verifiable credential 159 was issued, a timestamp indicating when the verifiable credential 159 will expire, and/or a proof mechanism that can be used by third parties to verify the authenticity and/or integrity of the verifiable credential 159. The proof mechanism can include a variety of approaches, such as a digital signature by the issuer of the verifiable credential 159 or a trusted verifying party (e.g., the verifier service 153), a token with a respective digital signature for the token, a zero-knowledge proof scheme, etc.

The components executed by the verifier computing environment 106 can include a verifier service 153, and potentially other applications, services, processes, systems, engines, or functionality not discussed in detail herein. The verifier service 153 can be executed to certify ownership claims 126 issued by the custody service 143 and/or to verify ownership claims 126 on behalf of third-parties. For example, the verifier service 153 could use a verifier private key 156 to generate a cryptographic signature of a verifiable credential 159 for use as a proof of the verifiable credential 159 associated with the ownership claim 126. Likewise, the verifier service 153 can be executed to confirm that a verifiable credential 159 issued for an ownership claim 126 is valid.

The client device 109 is representative of a plurality of client devices 109 that can be coupled to the network 119. The client device 109 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 109 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 109 or can be connected to the client device 109 through a wired or wireless connection.

The client device 109 can be configured to execute various applications such as a browser 166 or an identity wallet 169. The browser 166 can be executed by a client device 109 to access network such as web pages provided by an asset marketplace where NFTs 123 can be purchased or sold, such as the exchange 111. The identity wallet 169 can be used to manage the identification credentials of the user of the client device 109, such as the credentials or data that form the owner identifier 139 and/or the verifiable credentials 159 issued by the verifier service 153. The client device 106 can be configured to execute additional applications such as email applications, social networking applications, word processors, spreadsheets, or other applications.

As previously mentioned, the exchange 111 can represent one or more computing devices, computing resources, and/or applications or services that allow users to list NFTs 123 for sale and/or bid on or purchase NFTs 123. Examples of exchanges 111 include digital marketplaces such as OPENSEA®, NIFTY GATEWAY®, FANOPOLY®, and TOPSHOT®.

Next, a general description of the operation of the various components of the network environment 100 is provided. The following description is provided for illustrative purposes. However, other operations and interactions are also possible depending on the particular implementation and/or transaction.

To begin, a user registers his owner identifier 139 as a decentralized identifier (DID) 127 in the identity ledger 116. The DID 127 can include information identifying the user (e.g., name, contact information, etc.) and a public key that can be used to identify the user.

Subsequently, an NFT 123 can be listed on the NFT exchange 111 for purchase. The user can purchase the NFT 123 from the NFT exchange 111. Either as part of the purchase process or subsequent to the purchase, the user can request that the NFT 123 be held or maintained by the custody service 143.

The custody service 143 can then take public ownership of the NFT 123. For example, the custody service 143 could record its NFT owner public key 133 as the NFT owner public key 133 for the NFT 123 in the asset ledger 113. Meanwhile, the custody service 143 could also create an asset record 149 to separately track ownership of the NFT 123. The asset record 149 could include the NFT identifier 129 of the NFT purchased by the user and the owner identifier 139 for the user.

Subsequent transfers of ownership of the NFT 123 could be recorded by updating the asset record 149 for the NFT 123. For example, if the user resold or transferred the NFT 123 to another user, the custody service 143 could update the asset record 149 for the NFT 123 to include the owner identifier 139 for the new owner. Meanwhile, the NFT owner public key 133 assigned to the NFT 123 would remain unchanged. As a result, the NFT 123 would still be identified as being owned by the custody service 143 and no network transaction fees (e.g., ETHEREUM gas fees) would need to be paid to the nodes of the asset ledger 113 as a result of the change in ownership. Moreover, the users could rely on the operator of the custody service 143 to maintain the security of the NFT owner private key 136, who would be more qualified and better equipped than most individual users.

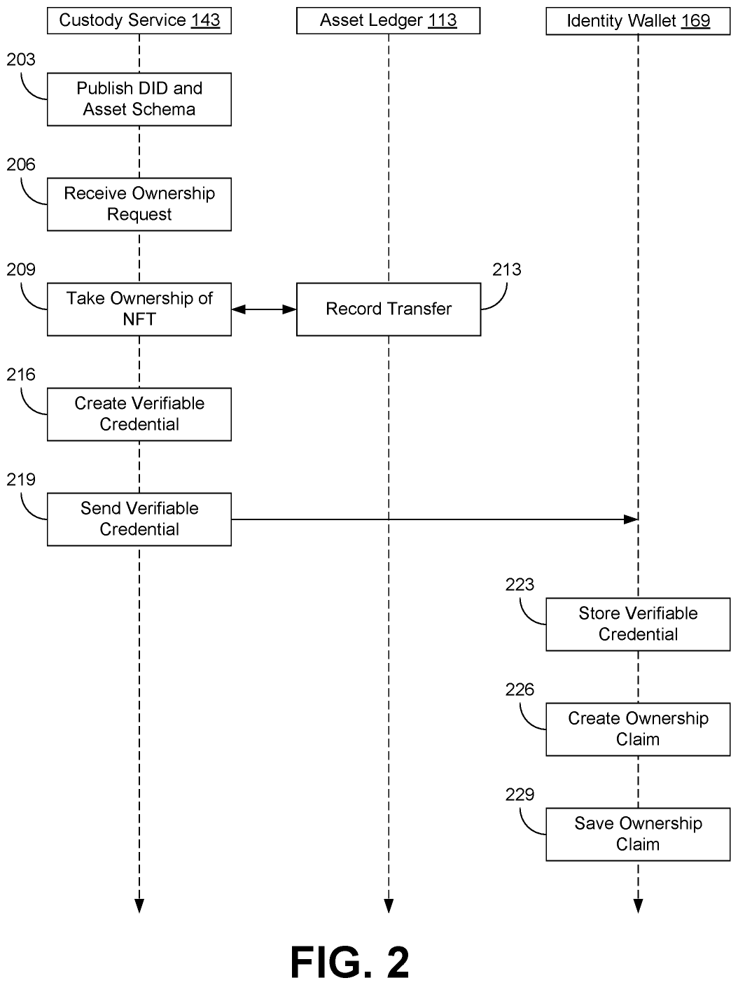

Referring next to FIG. 2, shown is a sequence diagram that provides one example of the interactions between the various components of the network environment 100 of FIG. 1. These interactions could be performed, for example, to allow an individual to acquire an NFT 123 using a custody service 143. The sequence diagram of FIG. 2 provides merely an example of the many different types of functional arrangements that can be employed to implement the operation of the depicted portions of the network environment 100. As an alternative, the sequence diagram of FIG. 2 can be viewed as depicting an example of elements of a method implemented within the network environment 100.

Beginning with block 203, the custody service 143 can publish its decentralized identifier 127 to the identity ledger 116. The decentralized identifier (DID) 127 could include a token signed by the NFT owner private key 136 managed by the custody service 143 and/or the NFT owner public key 133. This information can be used by other entities to verify the identity of the custodian operating the custodian computing environment 103 and/or custody service 143. In some instances, the schema that the custody service 143 uses to reference or refer to NFTs ###may also be published. Such schemas can specify the blockchain address used by the custody service 143, the NFT owner public key 133 used by the custody service 143, and other information. In some implementations, the schema could be included in the DID 127 published by the custody service 143 to the identity ledger 116.

Then, at block 206, the custody service 143 can receive a request from a customer to take ownership of an NFT 123 specified by the customer. This request to take ownership could be received in a number of contexts. For example, the user of a client device 109 could have purchased an NFT 123 through the exchange 111, or the exchange 111 could have sent a request to the custody service 143 to take ownership on behalf of the purchaser. As another example, the user could use a browser ###installed on the client device 109 to visit a webpage provided by the custody service 143 to provide the NFT identifier 129 and any other requisite information needed for the custody service 143 to take ownership of the NFT 123. In general, the request to take ownership of the NFT 123 will include at least the NFT identifier 129 of the NFT 123 and the owner identifier 139 of the individual requesting that the custody service 143 take possession of the NFT 123.

Next, at block 209, the custody service 143 can take ownership of the NFT 123. For example, the custody service 143 could invoke a method or function provided by the NFT 123 that allows for ownership of the NFT 123 to be updated. The custody service 143 could provide it's NFT owner public key 133 as an argument to the function, thereby updating the NFT owner public key 133. The custody service 143 can also create an asset record 149 to allow the custody service 143 to track ownership of the NFT 123 separately from the information stored in the asset ledger 113. For example, the custody service 143 could create an asset record 149 that includes the NFT identifier 129 of the NFT 123 and the owner identifier 139 of the owner associated with the request received at block 206.

Moving on to block 213, the asset ledger 113 can record the change in the ownership of the NFT 123. The asset ledger 113 can update the NFT 123 specified by the NFT identifier 129 to reflect the NFT owner public key 133 provided by the custody service 143. This will result in the public owner of the NFT 123 being listed as the operator of the custody service 143.

Proceeding to block 216, the custody service 143 can create a verifiable credential 159 that can be used by the customer who sent the request at block 206 to take ownership of the NFT 123 to prove that the customer is the owner of the NFT 123 held by the custody service 143. For example, the custody service 143 could generate the verifiable credential 159 and sign the verifiable credential 159 with the NFT owner private key 136. As another example, the custody service 143 could generate a token, sign the token with the NFT owner private key 136, and insert the signed token in the verifiable credential 159 for use as proof of authenticity. In some examples, where custody service 143 could instead provide a copy of the verifiable credential 159 to the verifier service 153. In these examples, the verifier service 153 could verify the authenticity of the verifiable credential 159 provided by the custody service 143 and then either sign the verifiable credential 159 with the verifier private key 163 or generate a signed token with the verifier private key 163, which could then be included in the verifiable credential 159. In these examples, the verifiable credential 159 could then be returned by the verifier service 153 to the custody service 143.

Referring next to block 219, the custody service 143 could then provide the verifiable credential 159 to the identity wallet 169 of the customer. This could be done using various secure transmission mechanisms. For the custody service 143 could use one or more mechanisms defined by the W3C DID standard to provide the verifiable credential 159 to the identity wallet 169 on the customer's client device 109.

Subsequently, at block 223, the identity wallet 169 can save or store on the client device 109 the verifiable credential 159 received from the custody service 143.

Proceeding to block 226, the identity wallet 169 can create an ownership claim 126. This may be done in response to receipt of the verifiable claim 159 so that the identity wallet 169 will know that the custody service 143 has successfully taken ownership of the NFT 123. To create the ownership claim 126, the identity wallet 169 can create a claim, such as a claim defined by the W3C DID standard, that asserts that the customer is the true owner of the NFT 123 saved in the asset ledger 113. Accordingly, the ownership claim 126 can include the NFT identifier 129 and the owner identifier 139 of the customer. In some implementations, however, the custody service 143 could create the ownership claim 126 instead of the identity wallet 169.

Next, at block 229, the identity wallet 169 can save the ownership claim 126 on the identity ledger 116. For example, the identity wallet 169 could write the ownership claim 126 to the identity ledger 116 or provide the ownership claim 126 to the identity ledger 116 for distribution across the nodes of the identity ledger 116. In those implementations where the custody service 143 created the ownership claim 126, however, the custody service 143 could instead save the ownership claim 126 on the identity ledger 116. As a result, the operator of the custody service 143 is recognized by the asset ledger 113 as the owner of the NFT 123, although the true or beneficial owner of the NFT 123 is identified by the ownership claim 126 stored in the identity ledger 116. New or updated ownership claims 126 can be saved to the identity ledger 116 to reflect changes in ownership of the NFT 123 without the custody service 143 having to transfer or update the NFT 123 in the asset ledger 113. This reduces transaction fees charged by the asset ledger 113 (e.g., gas fees charged by the ETHEREUM blockchain network) that may be associated with changes in the ownership of the NFT 123.

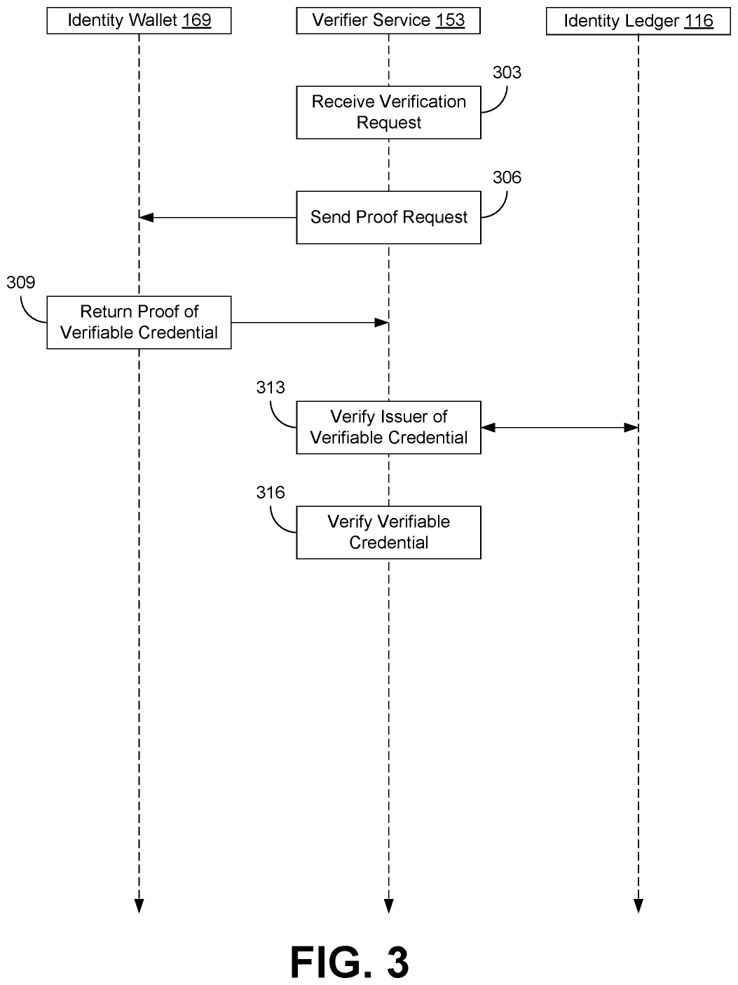

Referring next to FIG. 3, shown is a sequence diagram that provides one example of the interactions between the various components of the network environment 100 of FIG. 1. These interactions could be used, for example, to allow a third-party to verify that an individual owns a specified NFT 123. The sequence diagram of FIG. 3 provides merely an example of the many different types of functional arrangements that can be employed to implement the operation of the depicted portions of the network environment 100. As an alternative, the sequence diagram of FIG. 3 can be viewed as depicting an example of elements of a method implemented within the network environment 100.

Beginning at block 303, the verifier service 153 can receive a verification request. The verification request can be a request to verify or prove that an individual is the owner of an NFT 123 stored on the asset ledger. The verification request can include information such as the NFT identifier 129 of the NFT 123 and the owner identifier 139 of an individual (e.g., the decentralized identifier 127 used by an individual as his or her owner identifier 139). Other information can also be included in a verification request as desired for various implementations.

Proceeding to block 306, the verifier service 153 can send a proof request to the identity wallet 169 in response to receiving the verification request at block 303. The proof request can specify the verifiable credential 159 to be authenticated or verified, so that the identity wallet 169 can return the proof for the desired verifiable credential 159. For example, the proof request could specify the NFT 123 associated with the verifiable credential 159 (e.g., by including the NFT identifier 129 of the NFT 123).

Then, at block 309, the identity wallet 169 can search for the verifiable credential 159 and return a proof of authenticity or integrity to the verifiable credential 159 to the verifier service 153. For example, if the verifiable credential 159 had been signed by the custody service 143 or the verifier service 153, then the identity wallet 169 could return the signature of the verifiable credential 159. As another example, if the verifiable credential 159 includes a token that had been signed by the custody service 143 or the verifier service 153, the token and the cryptographic signature for the token could be returned to the verifier service 153 as proof of authenticity or integrity.

Next, at block 313, the verifier service 153 can verify the issuer of the verifiable credential. For example, the verifier service 153 could retrieve the distributed identifier (DID) 127 of the issuer of the verifiable credential 159 from the identity ledger 116. For example, if the custody service 143 had issued the verifiable credential 159, then the verifier service 153 could retrieve the DID 127 of the custody service from the identity ledger 116.

Subsequently, at block 316, the verifier service 153 can verify the authenticity of the verifiable credential 159. For example, the verifier service 153 could use the public key of the issuer of the verifiable credential 159, such as the NFT owner public key 133 maintained by the custody service 143, to verify the cryptographic signature of the verifiable credential 159. Similarly, the verifier service 153 could use the public key of the issuer of the verifiable credential 159, such as the NFT owner public key 133 maintained by the custody service 143, to verify the cryptographic signature of the token associated with the verifiable credential 159. If the verifier service 153 confirms the cryptographic signature using the public key retrieved from the DID 127 of the issuer of the verifiable credential 159, then the verifier service 153 could confirm that the holder of the verifiable credential 159 is the current owner of the NFT 123.

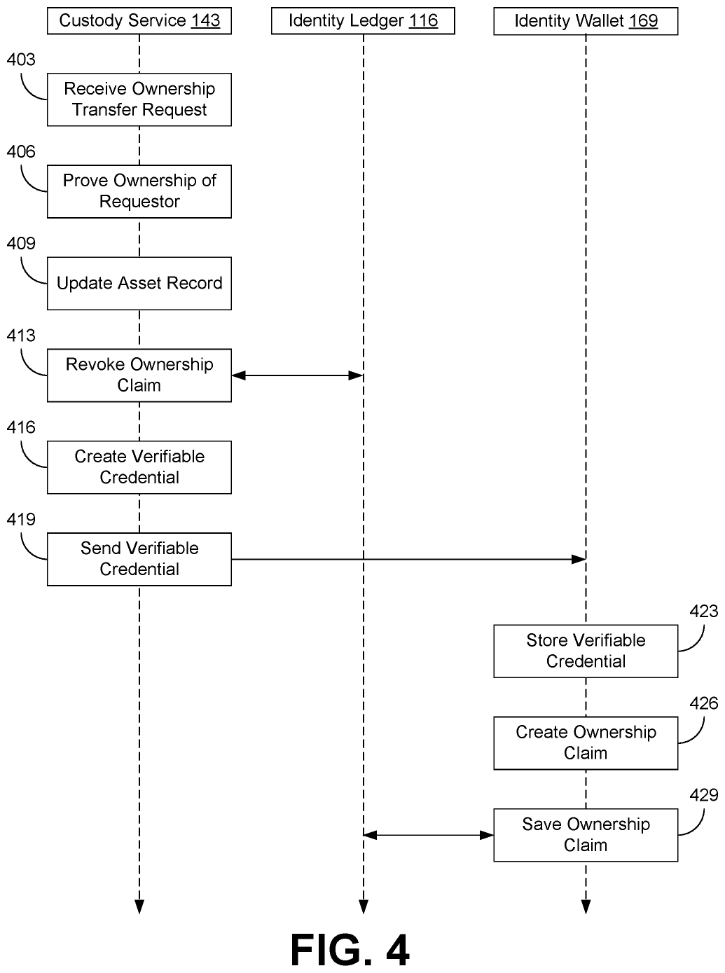

Referring next to FIG. 4, shown is a sequence diagram that provides one example of the interactions between the various components of the network environment 100 of FIG. 1. These interactions could be performed, for example, to allow a first individual to transfer ownership of an NFT 123 held by the custody service 143 to a second individual. The sequence diagram of FIG. 4 provides merely an example of the many different types of functional arrangements that can be employed to implement the operation of the depicted portions of the network environment 100. As an alternative, the sequence diagram of FIG. 4 can be viewed as depicting an example of elements of a method implemented within the network environment 100.

Beginning with block 403, the custody service 143 can receive a request to transfer ownership of an NFT 123. The request could be received in a variety of contexts. For example, the request could be received from the exchange 111 in response to a sale of the NFT 123 on the exchange 111 by the current owner. As another example, the current owner of the NFT 123 could send the request (e.g., due to the current owner gifting the NFT 123 to another or in response to the current owner completing a private sale of the NFT 123). The request to transfer the ownership of the NFT 123 could include data such as the NFT identifier 129, the owner identifier 139 of the new owner of the NFT 123, and information sufficient to authenticate the current owner of the NFT 123 with the custody service 143.

Then, at block 406, the custody service 143 can prove or verify ownership of the NFT 123. The process used to prove or verify ownership of the NFT 123 has been previously described in the discussion of FIG. 3.

Once the custody service 143 verifies the ownership of the NFT 123, the custody service 143 can update its asset record 149 to reflect the new owner of the NFT 123. For example, the custody service 143 could search for an asset record 149 with a matching NFT identifier 129 and update the owner identifier 139 in the asset record 149 to match the owner identifier 139 of the new owner, as specified in the request received at block 403.

After updating its asset record 149, the custody service 143 can revoke or invalidate any previous ownership claims 126 stored in the identity ledger 116 art block 413. For example, the custody service 143 could update an existing ownership claim 126 so that its status shows that it is invalid or revoked. As another example, the custody service 143 could add the previous ownership claim 126 to a revocation list that identifies all ownership claims 126 for an NFT 123 that are no longer recognized by the custody service 143. In some instances, the updated revocation list may be republished by the custody service 143.

Then, at block 416, the custody service 143 can create a verifiable credential 159 that can be used by the new owner of the NFT 123 to prove that the new owner is the owner of the NFT 123 held by the custody service 143. For example, the custody service 143 could generate the verifiable credential 159 and sign the verifiable credential 159 with the NFT owner private key 136. As another example, the custody service 143 could generate a token, sign the token with the NFT owner private key 136, and insert the signed token in the verifiable credential 159 for use as proof of authenticity. In some examples, where custody service 143 could instead provide a copy of the verifiable credential 159 to the verifier service 153. In these examples, the verifier service 153 could verify the authenticity of the verifiable credential 159 provided by the custody service 143 and then either sign the verifiable credential 159 with the verifier private key 163 or generate a signed token with the verifier private key 163, which could then be included in the verifiable credential 159. In these examples, the verifiable credential 159 could then be returned by the verifier service 153 to the custody service 143.

Referring next to block 419, the custody service 143 could then provide the verifiable credential 159 to the identity wallet 169 of the new owner of the NFT 123. This could be done using various secure transmission mechanisms. For the custody service 143 could use one or more mechanisms defined by the W3C DID standard to provide the verifiable credential 159 to the identity wallet 169 on the client device 109 of the new owner.

Subsequently, at block 423, the identity wallet 169 of the new owner can save or store on the client device 109 the verifiable credential 159 received from the custody service 143.

Proceeding to block 426, the identity wallet 169 can create an ownership claim 126. This may be done in response to receipt of the verifiable claim 159 so that the identity wallet 169 will know that the custody service 143 has successfully updated the asset record that records the ownership of the NFT 123. To create the ownership claim 126, the identity wallet 169 can create a claim, such as a claim defined by the W3C DID standard, that asserts that the new owner of the NFT 123 is the true owner of the NFT 123 saved in the asset ledger 113. Accordingly, the ownership claim 126 can include the NFT identifier 129 and the owner identifier 139 of the new owner. In some implementations, however, the custody service 143 could create the ownership claim 126 instead of the identity wallet 169.

Next, at block 429, the identity wallet 169 can save the ownership claim 126 on the identity ledger 116. For example, the identity wallet 169 could write the ownership claim 126 to the identity ledger 116 or provide the ownership claim 126 to the identity ledger 116 for distribution across the nodes of the identity ledger 116. In those implementations where the custody service 143 created the ownership claim 126, however, the custody service 143 could instead save the ownership claim 126 on the identity ledger 116. As a result, the change in ownership of the NFT 123 can be recorded without having to transfer or update the NFT 123 in the asset ledger 113, which continues to show the custody service 143 as the owner of the NFT 123. This reduces transaction fees charged by the asset ledger 113 (e.g., gas fees charged by the ETHEREUM blockchain network) that may be associated with changes in the ownership of the NFT 123.

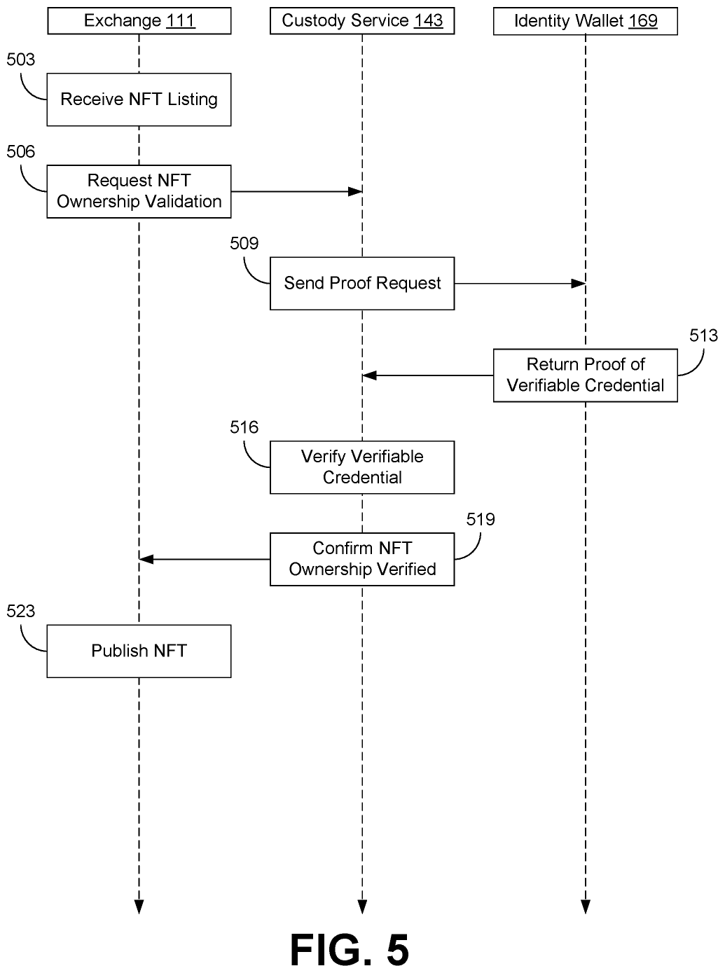

Referring next to FIG. 5, shown is a sequence diagram that provides one example of the interactions between the various components of the network environment 100 of FIG. 1. These interactions could be performed, for example, to allow an owner of an NFT 123 to list the NFT 123 for sale on an exchange 111 using the custody service 143. The sequence diagram of FIG. 5 provides merely an example of the many different types of functional arrangements that can be employed to implement the operation of the depicted portions of the network environment 100. As an alternative, the sequence diagram of FIG. 5 can be viewed as depicting an example of elements of a method implemented within the network environment 100.

Beginning with block 503, the exchange 111 can receive a listing for an NFT 123 or a notification of a listing of the NFT 123. For example, an owner of the NFT 123 could have listed the NFT 123 for sale on the exchange 111. The listing notification for the NFT 123 can include an NFT identifier 129. In some instances, it could also include the owner identifier 139 (e.g., if provided by the user listing the NFT 123).

Then, at block 506, the exchange 111 can send a request to the custody service 143 to validate the NFT 123. The validation request can include the NFT identifier 129 of the NFT to be validated. The validation request can also include the owner identifier 139 of the purported owner of the NFT 123 in some implementations.

Next, at block 509, the custody service 143 can send a proof request to the identity wallet 169 in response to receiving the validation request at block 506. The proof request can specify the verifiable credential 159 to be authenticated or verified, so that the identity wallet 169 can return the proof for the desired verifiable credential 159. For example, the proof request could specify the NFT 123 associated with the verifiable credential 159 (e.g., by including the NFT identifier 129 of the NFT 123).

Moving to block 513, the identity wallet 169 can search for the verifiable credential 159 and return a proof of authenticity or integrity to the verifiable credential 159 to the custody service 143. For example, if the verifiable credential 159 had been signed by the custody service 143 or the verifier service 153, then the identity wallet 169 could return the signature of the verifiable credential 159. As another example, if the verifiable credential 159 includes a token that had been signed by the custody service 143 or the verifier service 153, the token and the cryptographic signature for the token could be returned to the custody service 153.

Proceeding to block 516, the custody service 143 can use the proof received from the identity wallet 169 to verify the verifiable credential 159. For example, the custody service 143 could use the NFT owner public key 133 maintained by the custody service 143 to verify the cryptographic signature of the verifiable credential 159 or the cryptographic signature of the token stored with the verifiable credential 159. If the cryptographic signature generated by the custody service 143 matches the cryptograph signature provided by the identity wallet 169 in response to the proof request, then the custody service 143 can determine that the owner of the verifiable credential 159 is the owner of the NFT 123.

Then, at block 519, the custody service 143 can send a message to the exchange 111 confirming ownership of the NFT 123. This message could include an indication that the owner identifier 139 identifies the true owner of record for the NFT 123 and that the verifiable credential 159 confirming ownership is valid.

Subsequently, at block 513, the exchange 111 can publish the NFT 123 on the exchange for sale. The publication or listing of the NFT 123 can be done in response to the custody service 143 confirming the ownership of the NFT 123.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive from a custodian service a verifiable credential, the verifiable credential representing proof of ownership of a digital asset;
store the verifiable credential in the memory of the computing device;
receive a request for proof of ownership of the digital asset from the custodian service or a verifier service; and
provide a proof of the verifiable credential to the custodian service or the verifier service in response to the request for proof of ownership of the digital asset.

2. The system of claim 1, wherein the machine-readable instructions further cause the computing device to at least send an instruction to the custodian service to transfer ownership of the digital asset to another owner, the instruction specifying an owner identifier of the other owner.

3. The system of claim 1, wherein the proof of the verifiable credential comprises a cryptograph signature of the verifiable credential generated by the custodian service.

4. The system of claim 1, wherein the proof of the verifiable credential comprises a token issued by the custodian service and a cryptographic signature of the token, the cryptographic signature having been generated by the custodian service.

5. The system of claim 1, wherein the machine-readable instructions further cause the computing device to at least:
create an ownership claim in response to receipt of the verifiable credential, the ownership claim including a unique identifier for the digital asset and an identifier of the owner of the digital asset; and
publish the ownership claim to an identity ledger.

6. The system of claim 1, wherein the identifier of the owner of the digital asset is a decentralized identifier associated with the owner, the decentralized identifier containing a public key associated with the owner.

7. The system of claim 1, wherein the digital asset is a non-fungible token (NFT).

8. A method, comprising:
updating an owner identifier for a digital asset in an asset ledger to include a public key of an asset custodian, the public key of the asset custodian indicating that the asset custodian is the owner of the digital asset;
providing a verifiable credential to an identity wallet, the verifiable credential being linked to the digital asset in the digital asset ledger; and
creating an asset record that stores an owner identifier in association with an asset identifier for the digital asset, the owner identifier representing a user of the identity wallet.

9. The method of claim 8, further comprising:
signing the verifiable credential with a private key of the asset custodian to generate a cryptographic signature; and
including the cryptographic signature in the verifiable credential.

10. The method of claim 8, further comprising:
generating a token;
signing the token with a private key of the asset custodian to generate a cryptographic signature; and
including the token and the cryptographic signature in the verifiable credential.

11. The method of claim 8, wherein the owner identifier is a first owner identifier, the verifiable credential is a first verifiable credential, the identity wallet is a first identity wallet, and the method further comprises:
receiving a request to transfer ownership of the digital asset, the request to transfer the digital asset comprising a second owner identifier associated with a new owner of the digital asset;
updating the asset record to replace the first owner identifier with the second owner identifier;
revoking an ownership claim associated with the first owner identifier; and
providing a second verifiable credential to a second identity wallet, the second verifiable credential being linked to the digital asset in the digital asset ledger.

12. The method of claim 9, wherein revoking the ownership claim further comprises updating the ownership claim to reflect that it is revoked.

13. The method of claim 8, wherein revoking the ownership claim further comprises adding the ownership claim to a revocation list.

14. The method of claim 8, wherein the digital asset is a non-fungible token.

15. A system, comprising
a computing device comprising a processor and a memory; and
machine-readable instructions stored in the memory that, when executed by the processor, cause the computing device to at least:
update an owner identifier for a non-fungible token (NFT) in an asset ledger to include a public key of an asset custodian, the public key of the asset custodian indicating that the asset custodian is the owner of the NFT;
provide a verifiable credential to an identity wallet, the verifiable credential being linked to the NFT in the digital asset ledger; and
create an asset record that stores an owner identifier in association with an NFT identifier for the NFT, the owner identifier representing a user of the identity wallet.

16. The system of claim 15, wherein the machine-readable instructions, when executed by the processor, further cause the computing device to at least:
sign the verifiable credential with a private key of the asset custodian to generate a cryptographic signature; and
include the cryptographic signature in the verifiable credential.

17. The system of claim 15, wherein the machine-readable instructions, when executed by the processor, further cause the computing device to at least:
generate a token;
sign the token with a private key of the asset custodian to generate a cryptographic signature; and
include the token and the cryptographic signature in the verifiable credential.

18. The system of claim 15, wherein the owner identifier is a first owner identifier, the verifiable credential is a first verifiable credential, the identity wallet is a first identity wallet, and the machine-readable instructions, when executed by the processor, further cause the computing device to at least:
receive a request to transfer ownership of the NFT, the request to transfer the NFT comprising a second owner identifier associated with a new owner of the NFT;
update the asset record to replace the first owner identifier with the second owner identifier;
revoke an ownership claim associated with the first owner identifier; and
provide a second verifiable credential to a second identity wallet, the second verifiable credential being linked to the NFT in the digital asset ledger.

19. The system of claim 15, wherein the machine-readable instructions that cause the computing device to at revoke the ownership claim further cause the computing device to update the ownership claim to reflect that it is revoked.

20. The system of claim 15, wherein the machine-readable instructions that cause the computing device to at revoke the ownership claim further cause the computing device to add the ownership claim to a revocation list.
